(19) United States
(12) Patent Application Publication
(10) Pub. No.: US 2012/0308681 A1
(43) Pub. Date: Dec. 6, 2012

(54) Intelligent Slitting

(76) Inventor: Jamin Micarelli, Kirkland, WA (US)

(21) Appl. No.: 13/488,380

(22) Filed: Jun. 4, 2012

Related U.S. Application Data
(60) Provisional application No. 61/492,548, filed on Jun. 2, 2011.

(51) Int. Cl. B29C 43/18

(52) U.S. Cl. 425/389

(57) ABSTRACT

A system for managing elongation and stress dispersal in a bladder used during a deep draw high pressure process. Resilient bladder material is slitted at concentric or peripheral intervals from the bladder edge(s). The slits above are offset from slits below, such that as the bladder is stretched with deformational forces, the slits are widened, and as deformation forces are abated or relieved, the bladder and its slitting reassume their pre-deformation configurations.

This application claims priority to U.S. provisional application 61/492,548 filed Jun. 2, 2012.

### TECHNICAL FIELD

The disclosure relates to high pressure forming of composite parts and presses for same; more particularly, it relates to method and apparatus for managing elongation and stress dispersal in a bladder used during a deep draw high pressure process.

### BACKGROUND

In one kind of conventional deep draw press a work piece is positioned between a conventional movable deep draw forming die and an expandable bladder generally filled with fluid under pressure. This is sometimes referred to as a hydrostatic deep draw. The forming die is operated by a conventional ram cylinder and the bladder is some kind of a isostatic pressure vessel, all in a lidded, lockable pressure vessel.

In general, the vessel locks closed trapping a work piece, typically sheet metal, then high pressure is applied to the bladder from one side pinning the material to a flat platen on the other side. Once the material is under pressure, the hydraulic ram with a mold piece mounted on it is forced up through the bottom of the platen. Under full pressure the ram displaces liquid in the pressure chamber and in the process draws the flat material into a deep and complex shape. Deep draw in this kind of application generally refers to any draw where the depth of the draw is greater than half the diameter of the finished piece (also sometimes where the depth is greater than the diameter of the piece). Then the pressure in the bladder or isostatic vessel is lowered, the ram is retracted and the vessel is unlocked and opened to remove a finished formed part.

Examples of this kind of press may be found in Pryer Technology Group's Triform Hydroform Presses (http://www.pryertechgroup.com/about_hydroform.html).

Conventional high strength, low weight structural ballistic composites are made from materials such as fiberglass or graphite. The composite article is typically made of multiple layers of such material, sometimes combining one or more types of material. Conventionally such stacks of composite fabric are laid up over a mold or die and thereafter cured under selected temperature and pressure conditions.

There are a number of conventional press systems in use for making such composite articles. An autoclave is one kind of Hot Isostatic Press (HIP) which in general applies both heat and pressure to the workpiece placed inside of it. Typically, there are two classes of autoclave. Those pressurized with steam can process workpieces that are able to withstand exposure to water, while the other class circulates heated gas to provide greater flexibility and control of the heating atmosphere, and for pieces that cannot withstand exposure to water.

Processing by autoclave is far more costly than oven heating and is therefore generally used only when isostatic pressure must be applied to a workpiece of comparatively complex shape. For smaller flat parts, conventional heated presses offer much shorter cycle times. In other applications, the pressure is not required by the process but is integral with the use of steam, since steam temperature is directly related to steam pressure. Rubber vulcanizing exemplifies this category of autoclaving.

For exceptional requirements, such as the curing of ablative composite rocket engine nozzles and missile nosecones, a hydroclave can be used, but this entails extremely high equipment costs and elevated risks in operation. The hydroclave is pressurized with water (rather than steam); the pressure keeps the water in liquid phase despite the high temperature. Since the boiling point of water rises with pressure, the hydroclave can attain high temperatures without generating steam.

While simple in principle, this brings complications. Substantial pumping capacity is needed, since even the slight compressibility of water means that the pressurization stores non-trivial energy. Seals that work reliably against air or another gas fail to work well with extremely hot water. Leaks behave differently in hydroclaves, as the leaking water flashes into steam, and this continues for as long as water remains in the vessel. For these and other reasons, very few manufacturers will consider making hydroclaves, and the prices of such machines reflect this.

U.S. Pat. No. 7,862,323 (incorporated herein by reference) discloses a new kind of HIP press or pressure chamber where both heat and isostatic pressure can be applied to layered composites over comparatively complex shapes. We call such a press or pressure chamber a Boroclave. The Boroclave does not use water as a pressuring or pressure transfer medium. A Boroclave can be either oil or silicon filled, or a combination of both, with suitable separation materials. This Boroclave press is filled with a substantially incompressible medium such as silicone, where the medium at least partially encloses an elastomeric vessel filled with fluid such as oil or water and in fluid communication with a source of pressurized fluid, such that, as the vessel is pressurized inside the transfer medium, the pressure expands throughout the medium to provide a substantially uniform pressure to the work piece against the mold. The Boroclave advantageously employs a barrier or bladder to separate the pressure transfer medium itself from the layers of the composite article which is being fabricated.

When such a bladder is expanded, either due to molding pressures, or during the deep draw process, there is considerable stress on the holes in the periphery of the bladder that are used for passing through the locking bolts for holding the bladder in place. Under this stress the holes expand and at least some of the pressure medium, whether oil or silicone, leaks out from deformed through-holes around the bolts at the attachment points. What is needed is a means for ameliorating or relieving such stress at the bolt holes.

### DISCLOSURE

A system and method for ameliorating or relieving stress at bladder through holes is disclosed. The disclosed system manages elongation and stress dispersal in a bladder used during a deep draw high pressure process. A resilient bladder material is slitted at concentric or peripheral intervals from the bladder edge(s), with the slits above advantageously offset from the slits below, such that as the bladder is stretched with deformational forces, the slits are widened. As deformation forces are abated or relieved, the bladder and its slitting reassume their pre-deformation configurations.

### BRIEF DESCRIPTION OF DRAWINGS

FIGS. 1 and 2 are schematic illustrations of prior art modes.

FIGS. 3 and 4 are schematic illustrations of aspects of the disclosed technology.

### BEST MODE

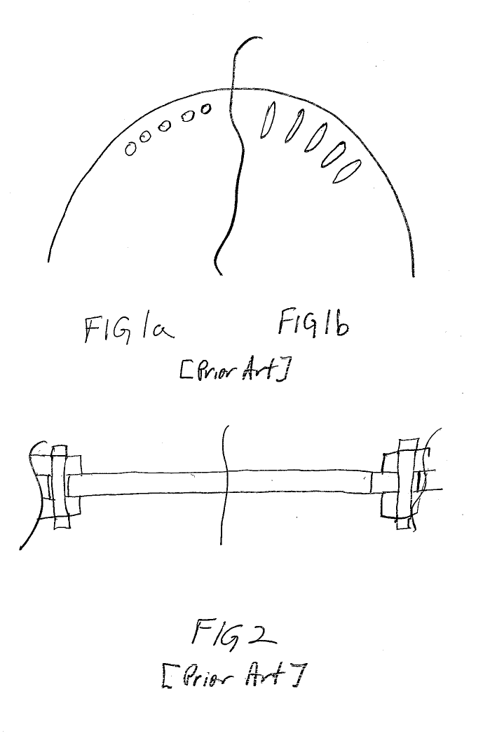

FIGS. 1 and 2 are typical of prior art bladder installations using bolts, and through-holes in the bladder edges for the bolts, to hold the bladder in place in the press. In FIG. 1a the unexpanded or resting hole shapes are shown (bolts not shown for clarity of illustration). On the right side of the figurative dividing line, which is denoted FIG. 1b, the distended, expanded or stressed hole shapes are illustrated, which result from considerable bladder deformations.

FIG. 2 is an alternate schematic cross-section of the same bladder, again with unexpanded holes on the left and expanded holes on the right. This time the bolts are shown for reference in illustrating the relative hole deformation on the right hand side of the figure.

FIG. 4 schematically illustrates an otherwise conventional bolt and through-hole attachment of a bladder edge at the bladder edge attachment point in the press. However, it can be seen that inboard of the attachment point there is a mass of bladder material that is slitted in such a way that, upon commencement of bladder deformation, the mass is pulled gradually into the shape denoted by the dotted lines in the figure, and into the shape thus shown by the dotted lines. It can be seen that, under the influence of the deformational forces (generally in the directions of the arrows shown), the slit is widened, gradually at first, and the mass assumes a more rounded shape as bladder material is pulled in the direction of the deformational forces.

Surprisingly, such a slitted-mass arrangement relieves most if not all of the stress on the bolt through-holes, which therefore in turn experience almost no deformation at all, or at least no significant deformation. The result is that pressure medium, whether oil or silicone, does not leak out from deformed through-holes around the bolts at the attachment points; rather, the through-holes around the bolts continue to perform their inherent sealing function without loss of performance through deformation.

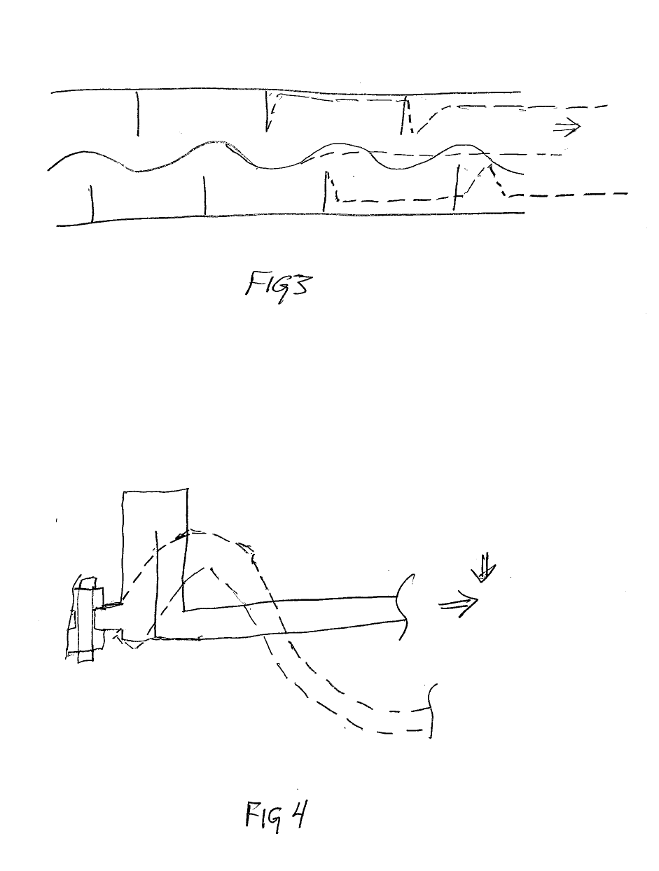

FIG. 3 schematically illustrates an alternate bladder cross-section. Instead of the slitted peripheral bladder mass of FIG. 4, the bladder material is slitted at concentric or peripheral intervals from the bladder edge(s). Advantageously, the slits above are offset from the slits below, and a wavy parting line is formed during bladder formation, such that as the bladder is stretched with deformational forces (generally in the direction of the arrow shown), the slits are widened as shown by the dotted lines, and the wavy line is straightened.

Not illustrated is the top view or plan view pattern of slitting, for instance in the embodiment depicted in FIG. 3. One variation in plan appearance is for the various slits that are shown in this figure to be more or less concentric rings of slits (ie in a roughly circular bladder, the slits would be rough circles). Another variation is for the slitting to be roughly wavy lines and still roughly concentric in plan view.

In each illustration, the bladder material is resilient enough so that as deformation forces are abated or relieved, the bladder and its slitting reassume their pre-deformation configurations, and this deformation/relaxation cycle can be repeated many times without damaging the bladder.

I claim:

1. A system for managing elongation and stress dispersal in a bladder used during a deep draw high pressure process, the system comprising:
resilient bladder material slitted at concentric or peripheral intervals from the bladder edge(s), the slits above offset from the slits below, such that as the bladder is stretched with deformational forces, the slits are widened, and as deformation forces are abated or relieved, the bladder and its slitting reassume their pre-deformation configurations.
